(19) United States
(12) Patent Application Publication
(10) Pub. No.: US 2023/0054087 A1
(43) Pub. Date: Feb. 23, 2023

(54) DENTAL WATER JET DEVICE AND WATER TANK THEREOF

(71) Applicant: PORClean Nano-Biochem Co., Ltd, Kaohsiung City (TW)

(72) Inventor: Jian-Chi Lee, Kaohsiung City (TW)

(21) Appl. No.: 17/491,537

(22) Filed: Oct. 1, 2021

(30) Foreign Application Priority Data
Aug. 19, 2021 (TW) 110130694

(51) Int. Cl. A61C 17/02

(52) U.S. Cl. CPC A61C 17/02

(57) ABSTRACT

A water tank used for a dental water jet device includes a box and a water pipe. The box has a top and a bottom opposite to each other. An upper side of the bottom facing the top has a water guiding surface and a water collecting area. The water guiding surface extends obliquely downward from an edge of the upper side to the water collecting area. The water pipe extends from the water collecting area to pass through the top, and has a water outlet above the top. A dental water jet device having the water tank is also provided.

### FIELD OF THE INVENTION

The present invention relates to an oral cleaning device, and more particularly to a dental water jet device and a water tank thereof.

### BACKGROUND OF THE INVENTION

In recent years, people's awareness of oral health care has gradually increased, and many oral cleaning-related products are sold on the market, wherein dental water jet devices are one of the most popular oral cleaning products in recent years.

The dental water jet device mainly uses a water jet mechanism to extract water from a water tank to generate a water jet flow to remove food residues between teeth, tartar and dental plaque. The dental water jet device is usually designed to be small in size for easy carrying due to that the users may still need to use the dental water jet device when they go out.

However, a large amount of water often remains inside the water tank and cannot be extracted in the process of using the conventional dental water jet device. Thus, water leakage often occurs when a user carries the conventional dental water jet device, thereby causing the problem of inconvenience to carry the conventional dental water jet device.

### SUMMARY OF THE INVENTION

The present invention provides a water tank to reduce the amount of water remaining inside the water tank.

The present invention further provides a dental water jet device to avoid water leakage when the dental water jet device is being carried.

An embodiment of the present invention provides a water tank suitable for a dental water jet device. The water tank includes a box and a water pipe. The box has a top and a bottom opposite to each other, and the upper side of the bottom facing the top has a water guiding surface and a water collecting area. The water guiding surface extends obliquely downward from an edge of the upper side to the water collecting area, and the water pipe extends from the water collecting area to pass through the top and has a water outlet located above the top.

In an embodiment of the present invention, the water pipe may be a hard water pipe and connected to the top.

In an embodiment of the present invention, the water tank further includes a filter element, which is disposed in the water collecting area and surrounds the water pipe.

In an embodiment of the present invention, the bottom has a through hole extending from the water collecting area to a lower side of the bottom opposite to the upper side. The filter element extends into the water tank through the through hole. A bottom wall of the filter element covers the through hole.

In an embodiment of the present invention, a hole wall of the above-mentioned through hole is provided with a first thread. An outer peripheral wall of the filter element is provided with a second thread. The first thread is suitable for screwing with the second thread to fix the filter element on the bottom.

In an embodiment of the present invention, the water tank further includes a sealing ring disposed between the through hole and the bottom wall of the filter element.

In an embodiment of the present invention, the water tank further includes a non-slip member. A groove is provided on the lower side of the bottom, and the non-slip member is disposed in the groove.

In an embodiment of the present invention, the sealing ring and the non-slip member are integrated as a whole.

In an embodiment of the present invention, the box further includes a side wall extending from an edge of the top to the bottom, and the bottom is detachably connected to the side wall.

The embodiment of the present invention further provides a dental water jet device, which includes the aforementioned water tank and a water jet mechanism. The water jet mechanism is connected to the water outlet of the water pipe of the water tank.

In the water tank of the embodiment of the present invention, the bottom of the box has a water guiding surface extending obliquely downward from the edge of the upper side of the bottom to the water collecting area. Thus, the water remaining in the box can flow and be collected at the water collecting area thereby being extracted out. Therefore, the amount of water remaining in the water tank can be significantly reduced. In addition, the dental water jet device of the embodiment of the present invention uses the above-mentioned water tank. Thus, the dental water jet device can prevent the water leakage when users are carrying it.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The present invention will become more readily apparent to those ordinarily skilled in the art after reviewing the following detailed description and accompanying drawings, in which:

FIG. 1 is a three-dimensional schematic diagram of a water tank according to an embodiment of the present invention;

FIG. 2 is a cross-sectional schematic diagram of the water tank of FIG. 1;

FIG. 3 is an exploded schematic diagram of a box and a filter element of the water tank in FIG. 1;

FIG. 4 is an exploded schematic diagram of a water tank according to another embodiment of the present invention; and

FIG. 5 is a cross-sectional schematic diagram of a dental water jet device according to an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

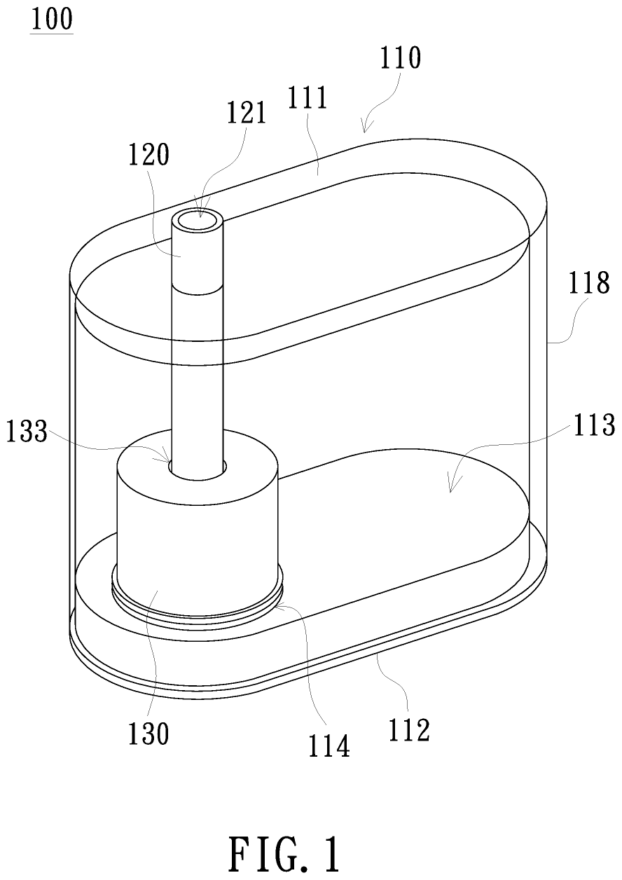

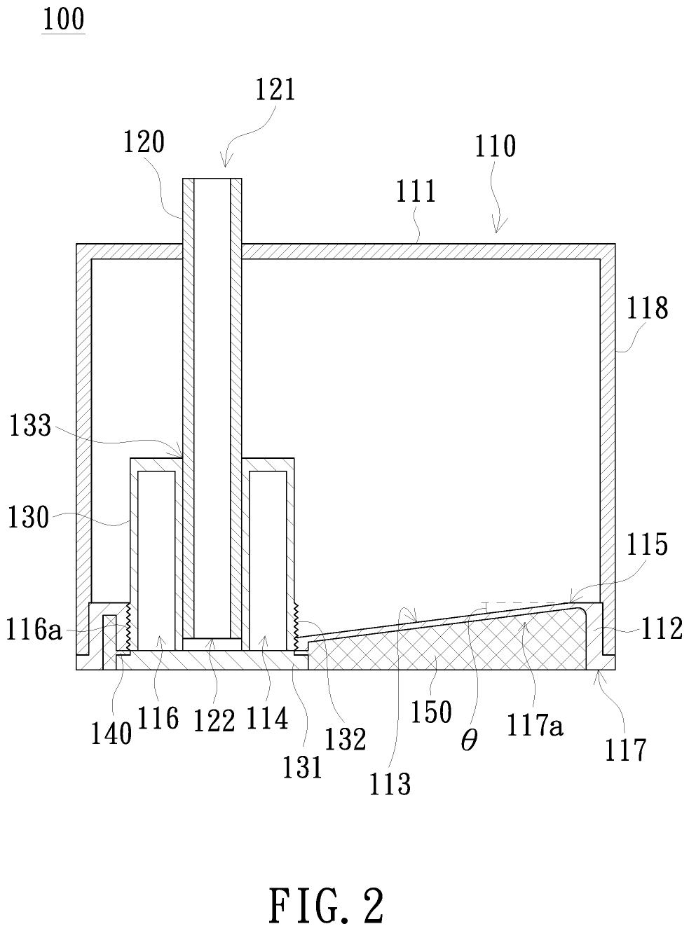

FIG. 1 is a three-dimensional schematic diagram of a water tank according to an embodiment of the present invention, and FIG. 2 is a cross-sectional schematic diagram of the water tank of FIG. 1. Please refer to FIGS. 1 and 2. The water tank 100 of the embodiment includes a box 110 and a water pipe 120. The box 110 has a top 111 and a bottom 112 opposite to each other. The upper side 115 of the bottom 112 facing the top 111 has a water guiding surface 113 and a water collecting area 114. The water guiding surface 113 extends obliquely downward from the edge of the upper side 115 to the water collecting area 114. The inclination angle θ of the water guiding surface 113 is, for example, between 5 and 10 degrees. For example, the inclination angle θ of the water guiding surface 113 is approximately 6 to 7 degrees. However, the inclination angle θ can be determined according to different design requirements and is not limited to the above. In addition, the water pipe 120 extends from the water collecting area 114 to pass through the top 111 and has a water outlet 121 located above the top 111. The water pipe 120 further has a water inlet 122 adjacent to the water collecting area 114.

The box 110 further includes a side wall 118 extending from the edge of the top 111 of the box 110 toward the bottom 112. The bottom 112 is, for example, detachably connected to the side wall 118. In another embodiment, the bottom 112 can also be configured to not detachable. In addition, the shape of the box 110 is, for example, an ellipsoid, but the invention is not limited thereto. For example, the shape of the box 110 may also be a three-dimensional shape such as a cube or a rectangular parallelepiped. In addition, the material of the box 110 can be a plastic material, but the invention is not limited thereto.

The water guiding surface 113 of the bottom 112 of the box 110 extends obliquely downward from the edge of the upper side 115 to the water collecting area 114, so that the water remaining inside the box 110 can flow and be collected at the water collecting area 114 thereby being effectively extracted. Therefore, the amount of water remaining in the box 110 can be greatly reduced.

In addition, the water pipe 120 of the embodiment may be a hard water pipe and is connected to the top 111. Specifically, the water pipe 120 may be configured to be fixedly connected to the top 111 and immovable, or may be configured to be movable relative to the top 111. The use of a hard water pipe can ensure that the water inlet 122 is located adjacent to the water collecting area 114, so that the amount of water remaining in the box 110 can be more effectively reduced. In another embodiment, the water pipe 120 may be a soft water pipe.

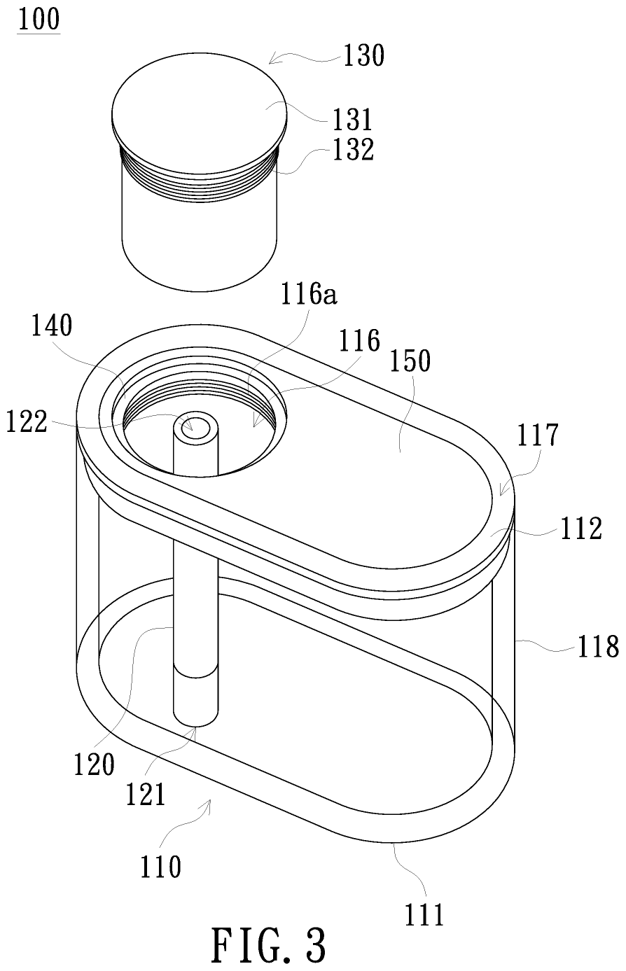

FIG. 3 is an exploded schematic diagram of the box and a filter element of the water tank in FIG. 1. Please refer to FIGS. 2 and 3. In the embodiment, the water tank 100, for example, further includes a filter element 130, which is disposed in the water collecting area 114 and surrounds the water pipe 120. Specifically, the filter element 130 has an insertion hole 133 for the water pipe 120 to be inserted. The filter element 130 surrounds the water pipe 120 when the water pipe 120 is inserted into the insertion hole 133. In addition, the filter element 130 is used for water filtration and can be disassembled and replaced regularly. In the embodiment, the bottom 112 of the box 110 has, for example, a through hole 116 extending from the water collecting area 114 to a lower side 117 of the bottom 112 opposite to the upper side 115. The filter element 130 can extend into the water tank 100 through the through hole 116. The bottom wall 131 of the filter element 130 covers the through hole 116.

Furthermore, the hole wall of the through hole 116 at the bottom 112 of the box 110 is provided with a first thread 116a, and the outer peripheral wall of the filter element 130 is provided with a second thread 132. The filter element 130 is fixed to the bottom 112 when the first thread 116a is screwed with the second thread 132. The present invention does not limit the combination of the filter element 130 and the bottom 112 in a screwed manner. For example, the filter element 130 can be fixed to the bottom 112 in a snap-fit manner.

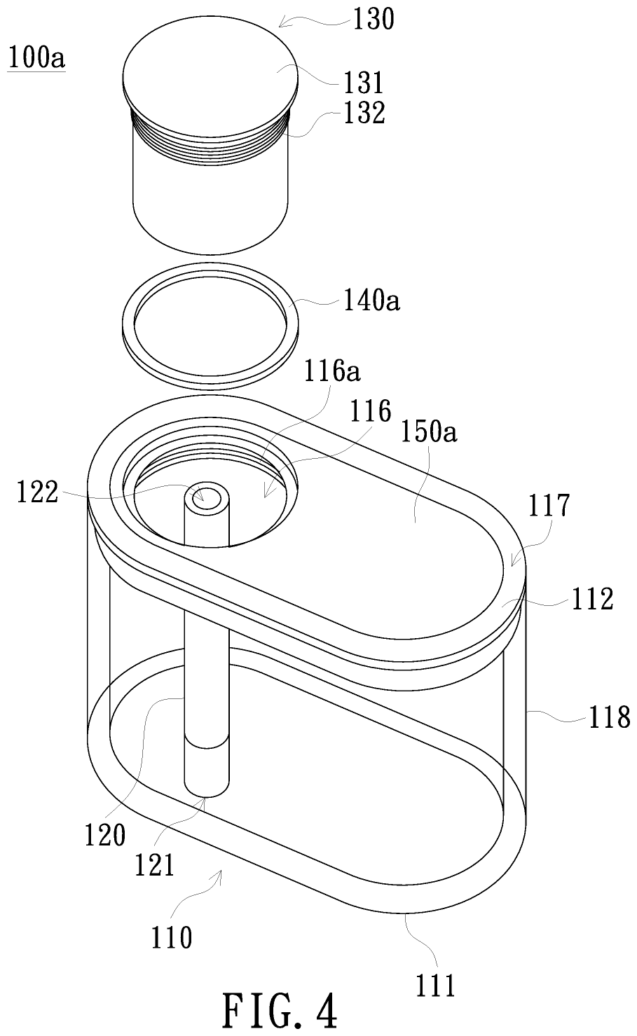

In the embodiment, the water tank 100 may further include a sealing ring 140, disposed between the through hole 116 and the bottom wall 131 of the filter element 130 to avoid water leakage. The material of the sealing ring 140 is, for example, rubber, but the invention is not limited thereto. In addition, the water tank 100 may further include a non-slip member 150. A groove 117a is provided on the lower side 117 of the bottom 112, and the non-slip member 150 is disposed in the groove 117a. The material of the non-slip member 150 may be rubber, but is not limited thereto. In the embodiment, the sealing ring 140 and the non-slip member 150 are, for example, integrated into a whole. In the water tank 100a of another embodiment shown in FIG. 4, the sealing ring 140a and the non-slip member 150a may be two separated elements.

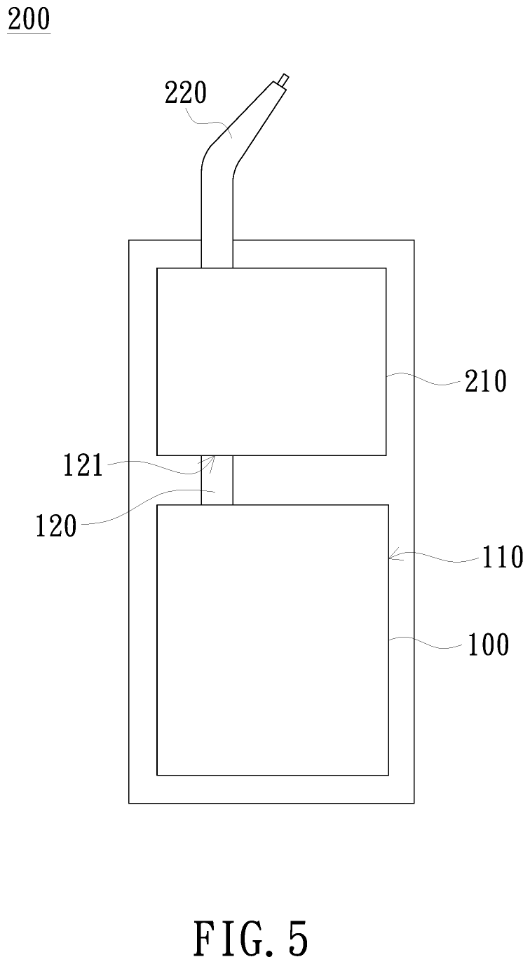

FIG. 5 is a cross-sectional schematic diagram of a dental water jet device according to an embodiment of the present invention. Please refer to FIG. 5. The dental water jet device 200 of the embodiment includes the above-mentioned water tank 100 and a water jet mechanism 210. The water jet mechanism 210 is connected to the water outlet 121 of the water pipe 120 of the water tank 100. The water jet mechanism 210 is connected to a nozzle assembly 220. The water jet mechanism 210 extracts the water in the water tank 100, and the nozzle assembly 220 jets the extracted water to form a water jet stream. The water tank 100 used in the dental water jet device 200 of this embodiment can greatly reduce the amount of water remaining in the box 110, therefore, it is not easy to cause water leakage when a user carries the dental water jet device 200.

In summary, in the water tank of the embodiment of the present invention, the bottom of the box has the water guiding surface extending obliquely downward from the edge of the upper side of the bottom to the water collecting area, so that the water remaining in the box can flow and be collected at the water collecting area thereby being extracted out. Therefore, the amount of water remaining in the water tank can be greatly reduced. In addition, the dental water jet device of the embodiment of the present invention uses the above-mentioned water tank. Thus, the dental water jet device can avoid the water leakage water when the user carries it, thereby enhancing the convenience of carrying. In addition, in an embodiment of the present invention, the use of a hard water pipe for the water pipe can ensure that the water inlet of the water pipe is adjacent to the water collecting area, so as to further reduce the amount of water remaining in the water tank.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A water tank suitable for a dental water jet device, the water tank comprising:
a box, having a top and a bottom opposite to each other, wherein an upper side of the bottom facing the top has a water guiding surface and a water collecting area, and the water guiding surface extends obliquely downward from an edge of the upper side to the water collecting area; and
a water pipe, extending from the water collecting area to pass through the top and having a water outlet located above the top.

2. The water tank according to claim 1, wherein the water pipe is a hard water pipe and is connected to the top.

3. The water tank according to claim 1, further comprising a filter element, disposed in the water collecting area and surrounding the water pipe.

4. The water tank according to claim 3, wherein the bottom has a through hole extending from the water collecting area to a lower side of the bottom opposite to the upper side, the filter element extends into the water tank through the through hole, and a bottom wall of the filter element covers the through hole.

5. The water tank according to claim 4, wherein a hole wall of the through hole is provided with a first thread, an outer peripheral wall of the filter element is provided with a second thread, and the first thread is suitable for screwing with the second thread to fix the filter element on the bottom.

6. The water tank according to claim 5, further comprising a sealing ring, disposed between the through hole and the bottom wall of the filter element.

7. The water tank according to claim 6, further comprising a non-slip member, wherein the lower side of the bottom is provided with a groove, and the non-slip member is disposed in the groove.

8. The water tank according to claim 7, wherein the sealing ring and the non-slip member are integrated as a whole.

9. The water tank according to claim 1, wherein the box further comprises a side wall extending from an edge of the top to the bottom, and the bottom is detachably connected to the side wall.

10. A dental water jet device, comprising:
a water tank, comprising:
a box, having a top and a bottom opposite to each other, wherein an upper side of the bottom facing the top has a water guiding surface and a water collecting area, and the water guiding surface extends obliquely downward from an edge of the upper side to the water collecting area; and
a water pipe, extending from the water collecting area to pass through the top and having a water outlet located above the top; and
a water jet mechanism, connected to the water outlet of the water pipe of the water tank.

11. The dental water jet device according to claim 10, wherein the water pipe is a hard water pipe and is connected to the top.

12. The dental water jet device according to claim 10, wherein the water tank further comprises a filter element, disposed in the water collecting area and surrounding the water pipe.

13. The dental water jet device according to claim 12, wherein the bottom has a through hole extending from the water collecting area to a lower side of the bottom opposite to the upper side, the filter element extends into the water tank through the through hole, and a bottom wall of the filter element covers the through hole.

14. The dental water jet device according to claim 13, wherein a hole wall of the through hole is provided with a first thread, an outer peripheral wall of the filter element is provided with a second thread, and the first thread is suitable for screwing with the second thread to fix the filter element on the bottom.

15. The dental water jet device according to claim 14, wherein the water tank further comprises a sealing ring, disposed between the through hole and the bottom wall of the filter element.

16. The dental water jet device according to claim 15, wherein the water tank further comprises a non-slip member, the lower side of the bottom is provided with a groove, and the non-slip member is disposed in the groove.

17. The dental water jet device according to claim 16, wherein the sealing ring and the non-slip member are integrated as a whole.

18. The dental water jet device according to claim 10, wherein the box further comprises a side wall extending from an edge of the top to the bottom, and the bottom is detachably connected to the side wall.
